(19) United States
(12) Patent Application Publication
(10) Pub. No.: US 2005/0121842 A1
(43) Pub. Date: Jun. 9, 2005

(54) C-clamp having dual fastening mechanism

(76) Inventor: Meei Feng Lo, Taichung City (TW)

Correspondence Address: PRO-TECHTOR INTERNATIONAL SERVICES, 20775 Norada Court, Saratoga, CA, 95070-3018, US

(21) Appl. No.: 10/732,504

(22) Filed: Dec. 9, 2003

(51) Int. Cl. B25B 1/00

(52) U.S. Cl. 269/6

(57) ABSTRACT

Disclosed is a C-clamp having dual fastening mechanism. Pivoting a pivotal handle about a fixed handle will cause a pin to contact and move a spring biased first fastening member to a slanted position, move a pawl backward along a ratchet, and move an abutment member to vertically dispose a second fastening member by urging against a resilient member, thereby fastening a shaft by both the first and second fastening members since the second fastening member is slanted immediately after releasing the pivotal handle, and stepwise fastening an object. Instead, pressing a quick release will disengage the pawl from the ratchet so as to pivot the pivotal handle to return the second fastening member to a vertical position through activation of the abutment member, and return the first fastening member to a slanted position, thereby enabling a removal of the object.

### BACKGROUND OF THE INVENTION

1. Field of the Invention

The present invention relates to clamps and more particularly to an improved C-clamp having dual fastening mechanism for increasing reliability.

2. Description of Related Art

Clamps are well known devices such as those disclosed in U.S. Pat. Nos. 5,217,213, 6,240,815 B1, 6,474,632 B1, and 6,450,489 B1. A prior clamp 10 is shown in FIG. 1. The clamp 10 comprises a movabl jaw 111, a fixed jaw 11, a hollow fixed handle 12, a pivotal handle 18 adjacent the fixed handle 12, a movable section 14 in an upper portion of the pivotal handle 18, a spring biased quick release 19, a lengthwise channel 13 through the upper portions of the handles 12 and 18, a lengthwise shaft 15 inserted through the channel 13, the shaft 15 having a forward end secured to a lower portion of the movable jaw 111, and two engaged fastening members 16 put on the shaft 15 and disposed in an upper cavity of the fixed handle 12, and a spring 17 put on the shaft 15 and biased between a rear side of the fastening members 16 and a wall of the cavity in the fixed handle 12.

In operation, an object is first placed between the jaws 111 and 11. Next, press the pivotal handle 18 rearwardly to pivot about and receive in the hollow fixed handle 12 so as to cause the movable section 14 to exert a force to pivot the fastening members 16 from a slanted position to a vertical position with the spring 17 being compressed. At this position, the shaft 15 is unfastened. Thus, a user can slide the shaft 15 until the object is held by the jaws 111 and 11. Next, release the pivotal handle 18 to cause the spring 17 to expand for disposing the fastening members 16 in a slanted position again. At this position, the shaft 15 is fastened and the object is held firmly by the jaws 111 and 11. However, the prior art suffered from several disadvantages. For example, the fastening is not reliable since there is no way for the user to feel an appropriate fastening of the object. This in turn may damage the object if it is not structurally strong and an excessive force is exerted. Furthermore, an unintentional contact with the quick release 19 may unfasten the object and even cause the object to fall on the ground. This is not safe.

Another prior clamp 20 is shown in FIG. 2. Its characteristics are that a ratchet 33 is formed on a bottom of the clamp body adjacent the fixed jaw 22. The spring biased quick release 30 has a top end shaped as a pawl 32 caught and held by a tooth of the ratchet 33. The unfastening or fastening of the shaft 25 is controlled by a spring biased fastening member 281 by pressing the pivotal handle 28 or not. The pawl 32 moves backward a tooth with the shaft 25 being unfastened when the pivotal handle 28 is pressed. That is, the shaft 25 is slidable at this position. By repeating the above procedure, it is possible of stepwise firmly holding an object between the jaws 26 and 21. To the contrary, a pressing of the quick release 30 will disengagement the pawl 32 from the tooth of the ratchet 33. At this position, it is possible of unfastening the shaft 25 for removing the object. However, the prior art still suffered from a disadvantage. For example, the fastening is not reliable since it is provided by a single fastening member 281. Hence, a need for improvement exists.

### SUMMARY OF THE INVENTION

It is an object of the present invention to provide a C-clamp having dual fastening mechanism for increasing-reliability in operation.

To achieve the above and other objects, the present invention provides a C-clamp comprising a body; a forward fixed jaw; a rear movable jaw coupled to an upwardly extending portion of the body, the movable jaw including a ball shaped projection and a pivotal engagement member having a recess shaped to fitly receive the projection so that an object having a flat side surface or a slanted side surface is adapted to be held firmly between the fixed jaw and the engagement member; a rear fixed handle extended downwardly from the body; a forward pivotal handle extended downwardly from the body to form an acute angle between the handles, the fixed handle having an upper, transverse pin; a forward first cavity in the body; a first fastening member in the first cavity proximate the pin; a spring having a forward end held by the first fastening member; a rear second cavity in the body; a hollow resilient member in the second cavity; a ratchet on a bottom of the body; a lengthwise channel through the body; a spring biased quick release pivotably coupled to the pivotal handle, the quick release having a top pawl adapted to be caught and held by the ratchet; a lengthwise shaft through the channel, the second cavity, the resilient member, the first cavity, and the first fastening member, the shaft having a forward end secured to a lower portion of the movable jaw wherein in an inoperative state of the pivotal handle, the shaft is unfastened as the first fastening member is vertically disposed in the first cavity; a hollow abutment member in a forward end of the second cavity with the shaft being passed therethrough, the abutment member being coupled to a rear end of the spring; and a hollow second fastening member put on the shaft, the second fastening member having a bottom in contact with bottoms of both the resilient member and the abutment member, and a top received and held captive in a recessed wall of the second cavity, whereby pivoting the pivotal handle about the fixed handle will cause the pin to contact and move the first fastening member to a slanted position by compressing the spring, move the pawl backward along the ratchet, and move the abutment member backward to cause the second fastening member to be disposed vertically by urging against the resilient member, thereby fastening the shaft by the first fastening member and the second fastening member since the second fastening member is slanted immediately after releasing the pivotal handle, and stepwise fastening the object; and pressing the quick release will disengage the pawl from the ratchet so as to pivot the pivotal handle to return the second fastening member to the vertical position through an activation of the abutment member, and return the first fastening member to the slanted position respectively, thereby enabling a removal of the object.

The above and other objects, features and advantages of the present invention will become apparent from the following detailed description taken with the accompanying drawings.

### BRIEF DESCRIPTION OF THE DRAWINGS

FIG. 1 is a side elevational view of a conventional clamp;

FIG. 2 is a side elevational view of another conventional clamp;

FIG. 3 is a side elevational view of a preferred embodiment of C-clamp according to the invention;

FIG. 4 is an exploded perspective view of abutment member, second fastening member, and resilient member all put on the shaft;

FIG. 5 is a side elevational view in part section of the movable jaw;

FIG. 6 is a side elevational view illustrating the fastening of an object; and

FIG. 7 is a side elevational view illustrating the fastening of an object having a slanted side surface.

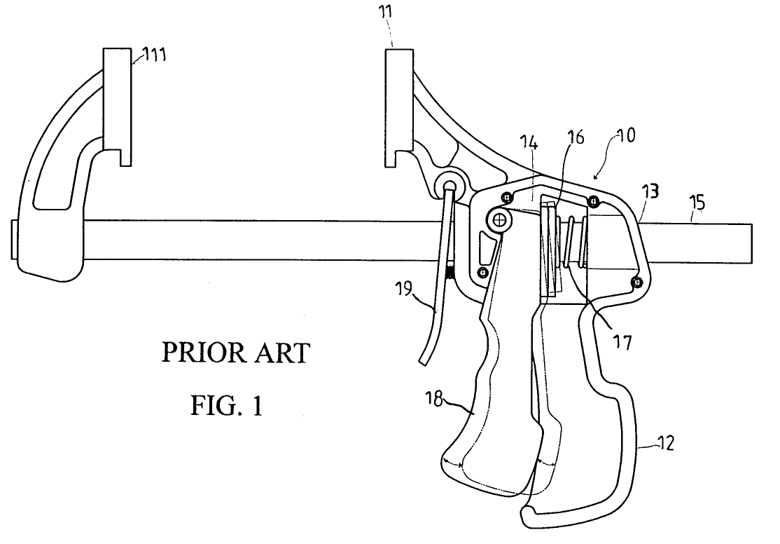

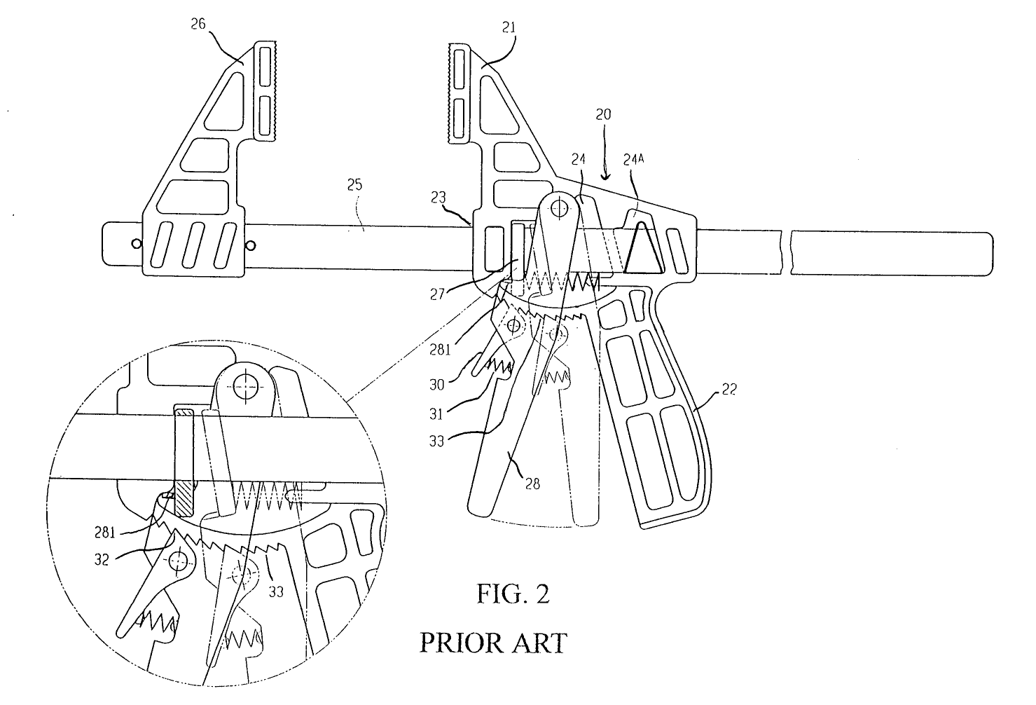

### DETAILED DESCRIPTION OF THE PREFERRED EMBODIMENTS

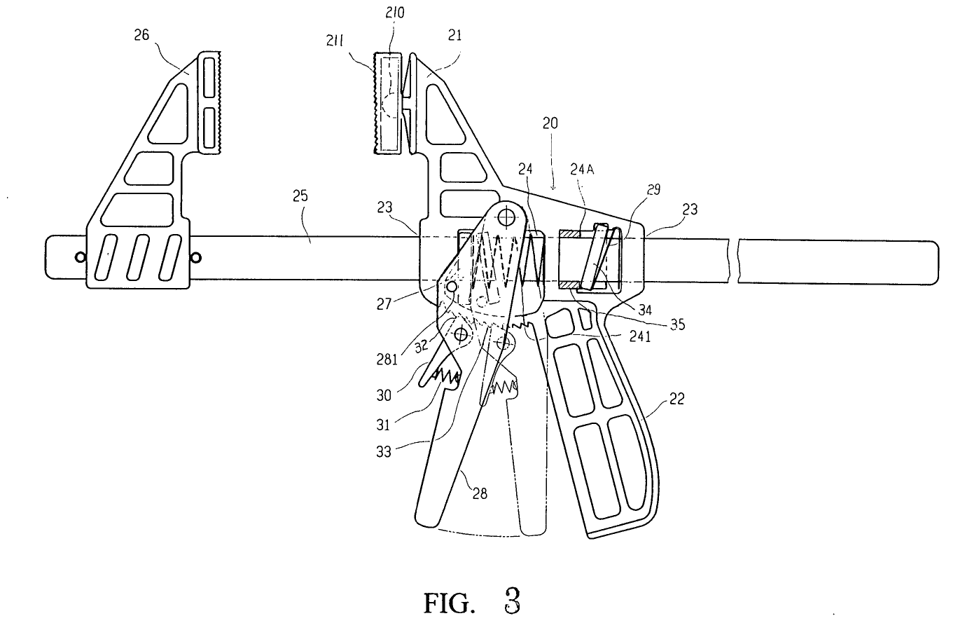

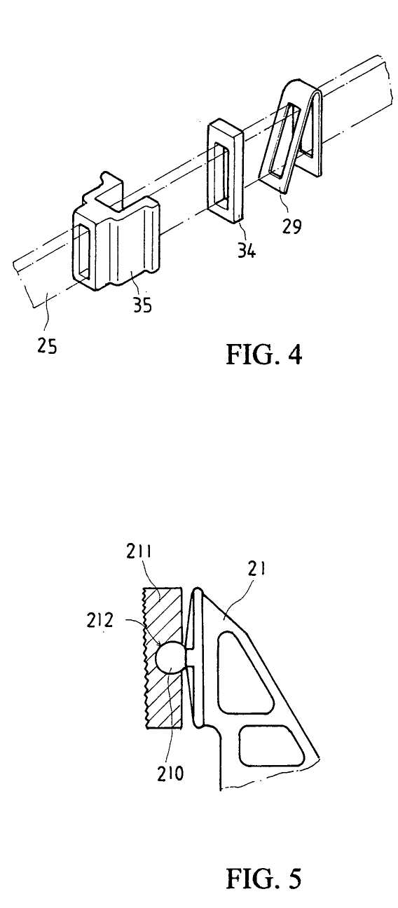

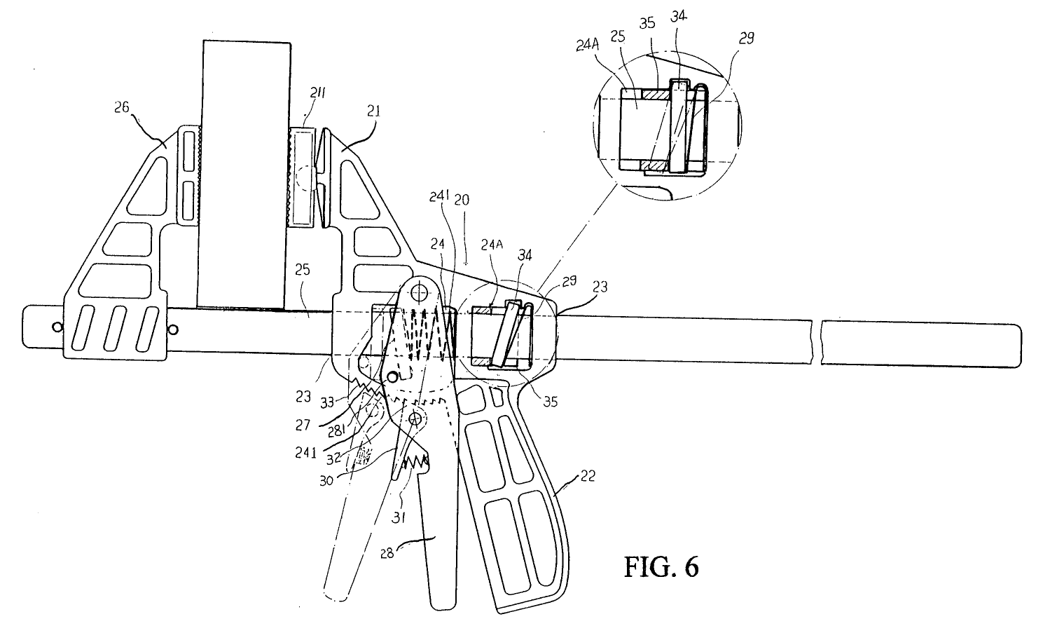

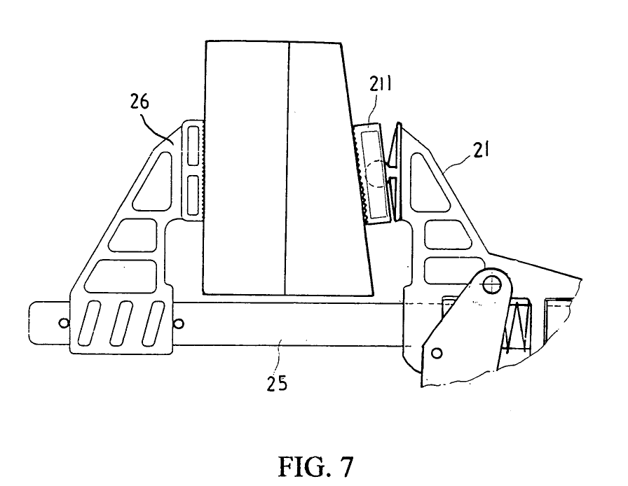

Referring to FIGS. 3 to 7, there is shown a C-clamp constructed in accordance with the invention. The clamp comprises a body 20, a fixed jaw 26, and a movable jaw 21 including a ball shaped projection 210 and an engagement member 211 having a recess 212 shaped to fitly, pivotably receive the projection 210. An object, having a flat side surface (see FIG. 6) or slanted one (see FIG. 7), is adapted to be held firmly between the toothed surfaces of the jaw 26 and the engagement member 211 since the engagement member 211 is slightly pivotal similar to a universal joint.

The body 20 comprises a fixed handle 22, a pivotal handle 28 adjacent the fixed handle 22, the pivotal handle 28 having an upper, transverse pin 281, a forward first cavity 24, a first fastening member 27 in the first cavity 24 proximate the pin 281, a spring 241 having a forward end held by the first fastening member 27, a rear second cavity 24A, a gable, hollow resilient member 29 in the second cavity 24A, a ratchet 33 formed on a bottom of the body 20 adjacent the fixed jaw 22, a quick release 30 pivotably coupled to the pivotal handle 28, the quick release 30 having a top end shaped as a pawl 32 being adapted to be caught and held by a tooth of the ratchet 33, and a lower spring 31 interconnected the quick release 30 and the pivotal handle 28 so as to smoothing the pivoting, a lengthwise shaft 25 through a lengthwise channel 23 of the body 20, the second cavity 24A, the resilient member 29, the first cavity 24, and the first fastening member 27, the shaft 25 having a forward end secured to a lower portion of the movable jaw 26, a hollow abutment member 35 in a forward end of the second cavity 24A with the shaft 25 passed therethrough, the abutment member 35 being coupled to a rear end of the spring 241, and a hollow second fastening member 34 put on the shaft 25, the second fastening member 34 having a bottom in contact with bottoms of both the resilient member 29 and the abutment member 35, and a top received and held captive in a recessed portion in the wall of the second cavity 24A.

In an inoperative state of the pivotal handle 28, the shaft 25 is unfastened since the first fastening member 27 is vertically disposed in the first cavity 24. At this position a user can slide the shaft 25 for holding an object between the toothed surfaces of the jaw 26 and the engagement member 211. For fastening the object press the pivotal handle 28 rearwardly to pivot about the fixed handle 22 so as to cause the pin 281 to exert a force to move the first fastening member 27 to a slanted position by compressing the spring 241. As such, the shaft 25 is fastened. At the same time, the pawl 32 moves backward a tooth and is always caught and held by the ratchet 33. Also, the abutment member 35 moves backward as biased by the compressed spring 241. This in turn causes the second fastening member 34 to be disposed vertically by urging against the resilient member 29. Further, the shaft 25 is fastened by the second fastening member 34 since the second fastening member 34 is slanted immediately after releasing the pivotal handle 28. By repeatedly pivoting and releasing the pivotal handle 28, it is possible of stepwise firmly holding the object between the toothed surfaces of the jaw 26 and the engagement member 211. This process can prevent the forward movement of the pivotal handle 28, maintain the first fastening member 27 to be urged by the pin 281, and maintain the shaft 25 to be fastened by both the first and the second fastening members 27 and 34. This is a dual fastening design. Hence, the fastening of the object is more reliable. Note that an unintentional contact with the quick release 30 (i.e., unfastening the shaft 25 secured by the first fastening member 27) will not unfasten the object since the shaft 25 is still fastened by the second fastening member 34. For removing the object, press the quick release 30 to disengage the pawl 32 from the tooth of the ratchet 33. At this position, it is possible of pivoting the pivotal handle 28 to return the second fastening member 34 to the vertical position through the activation of the abutment member 35, and return the first fastening member 27 to the slanted position respectively. At this position, a forward sliding of the shaft 25 is made possible, thereby enabling the removal of the object.

While the invention herein disclosed has been described by means of specific embodiments, numerous modifications and variations could be made thereto by those skilled in the art without departing from the scope and spirit of the invention set forth in the claims.

1. A C-clamp, comprising:
a body;
a forward fixed jaw;
a rear movable jaw coupled to an upwardly extending portion of the body, the movable jaw including a ball shaped projection and a pivotal engagement member having a recess shaped to fitly receive the projection so that an object having a flat side surface or a slanted side surface is adapted to be held firmly between the fixed jaw and the engagement member;
a rear fixed handle extended downwardly from the body;
a forward pivotal handle extended downwardly from the body to form an acute angle between the handles, the fixed handle having an upper, transverse pin;
a forward first cavity in the body;
a first fastening member in the first cavity proximate the pin;
a spring having a forward end held by the first fastening member;
a rear second cavity in the body;
a hollow resilient member in the second cavity;
a ratchet on a bottom of the body;
a lengthwise channel through the body;
a spring biased quick release pivotably coupled to the pivotal handle, the quick release having a top pawl adapted to be caught and held by the ratchet;
a lengthwise shaft through the channel, the second cavity, the resilient member, the first cavity, and the first fastening member, the shaft having a forward end secured to a lower portion of the movable jaw wherein in an inoperative state of the pivotal handle, the shaft is unfastened as the first fastening member is vertically disposed in the first cavity;
a hollow abutment member in a forward end of the second cavity with the shaft being passed therethrough, the abutment member being coupled to a rear end of the spring; and
a hollow second fastening member put on the shaft, the second fastening member having a bottom in contact with bottoms of both the resilient member and the abutment member, and a top received and held captive in a recessed wall of the second cavity,
whereby pivoting the pivotal handle about the fixed handle will cause the pin to contact and move the first fastening member to a slanted position by compressing the spring, move the pawl backward along the ratchet, and move the abutment member backward to cause the second fastening member to be disposed vertically by urging against the resilient member, thereby fastening the shaft by the first fastening member and the second fastening member since the second fastening member is slanted immediately after releasing the pivotal handle, and stepwise fastening the object; and pressing the quick release will disengage the pawl from the ratchet so as to pivot the pivotal handle to return the second fastening member to the vertical position through an activation of the abutment member, and return the first fastening member to the slanted position respectively, thereby enabling a removal of the object.

2. The C-clamp of claim 1, wherein the resilient member has a gable shape.
